(19) United States
(12) Patent Application Publication
(10) Pub. No.: US 2020/0377348 A1
(43) Pub. Date: Dec. 3, 2020

(54) LIFT SYSTEM OPTICAL AND RF COMBINATION REMOTE CONTROL

(71) Applicant: Vehicle Service Group, LLC, Madison, IN (US)

(72) Inventors: Darian SMITH, Madison, IN (US); Rob ELLIOTT, Madison, IN (US); Kevin KATERBERG, Madison, IN (US)

(21) Appl. No.: 16/862,498

(22) Filed: Apr. 29, 2020

Related U.S. Application Data
(60) Provisional application No. 62/853,241, filed on May 28, 2019.

(51) Int. Cl. B66F 3/46; B66F 5/04

(52) U.S. Cl. CPC B66F 3/46; B66F 5/04

(57) ABSTRACT

A vehicle lift system includes a plurality of mobile lift columns each including a wireless communication system for sending and receiving wireless signals, at least one of the mobile lift columns including an optical receiver. A remote control unit having a wireless communication system capable of transmitting wireless control signals and the remote control unit having an optical transmitter. A control unit is associated with the plurality of lift columns for controlling operation of the plurality of lift columns. The control unit receiving control signals from the wireless communication system and the optical receiver and enabling operation of the mobile lift columns when both an optical signal transmitted by the remote control unit is received by the optical receiver and a wireless control signal transmitted by the remote control unit is received by the wireless communication system.

### CROSS-REFERENCE TO RELATED APPLICATIONS

This application claims the benefit of U.S. Provisional Application No. 62/853241, filed on May 28, 2019. The entire disclosure of the above application is incorporated herein by reference.

### FIELD

The present disclosure relates to a lift system for optical and RF combination remote control.

### BACKGROUND

This section provides background information related to the present disclosure which is not necessarily prior art.

Vehicle lift systems may be used to lift various kinds of vehicles relative to the ground. Some vehicle lift systems are formed by a set of mobile above-ground lift columns. The mobile columns may be readily positioned in relation to the vehicle. The mobile columns may then be activated to lift the vehicle from the ground on a coordinated/synchronized fashion. It may be desirable to provide a reliable wireless control for a set of mobile lift columns.

### SUMMARY

This section provides a general summary of the disclosure, and is not a comprehensive disclosure of its full scope or all of its features.

A vehicle lift system includes a plurality of mobile lift columns each including a wireless communication system for sending and receiving wireless signals, at least one of the mobile lift columns including an optical receiver. A remote control unit having a wireless communication system capable of transmitting wireless control signals and the remote control unit having an optical transmitter. A control unit is associated with the plurality of lift columns for controlling operation of the plurality of lift columns. The control unit receiving control signals from the wireless communication system and the optical receiver and enabling operation of the mobile lift columns when both an optical signal transmitted by the remote control unit is received by the optical receiver of the at least one of the mobile lift columns and a wireless control signal transmitted by the remote control unit is received by the wireless communication system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary lift system;

FIG. 2 is a perspective front view of an exemplary lift column of the lift system;

FIG. 3 is a block schematic diagram of the lift system of FIG. 1;

FIG. 4 is a flow diagram of the control operation for restricting remote operation of a lift system according to the principles of the present disclosure;

FIG. 5 is a flow diagram of the control operation for restricting remote operation of a lift system according to a second embodiment of the present disclosure; and

FIG. 6 is a flow diagram of the control operation for restricting remote operation of a lift system according to a third embodiment of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

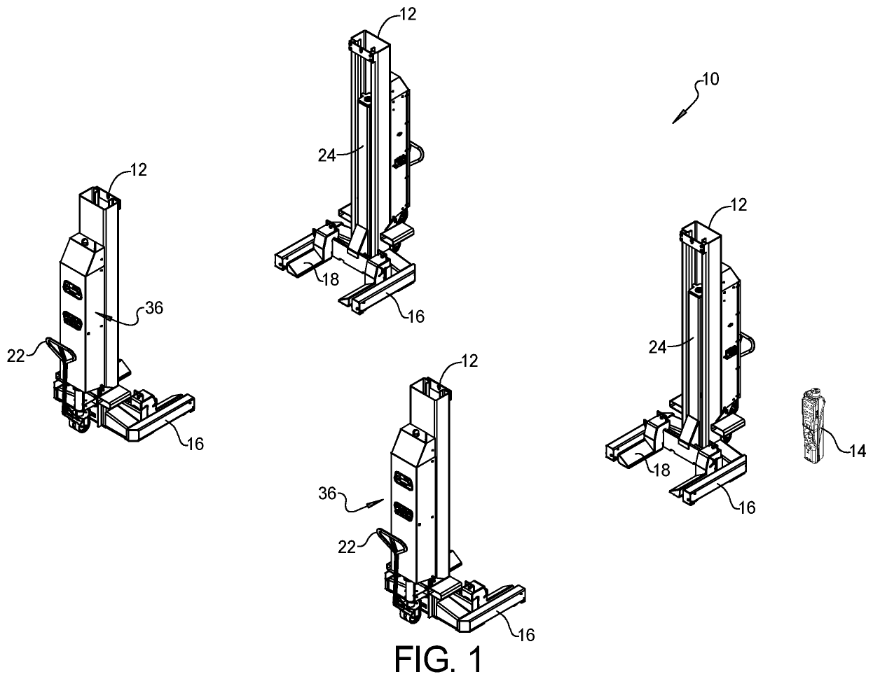

FIG. 1 illustrates an exemplary lift system 10 comprising a plurality of mobile lifting columns 12 and a remote control unit 14. The remote control unit 14 is operable for controlling the lifting columns 12 to selectively raise or lower a vehicle relative to the ground. While four columns 12 are shown, it should be understood that any other suitable number of columns 12 (e.g., six, eight, etc.) may be used to form the lift system 10. Each lifting column 12 is shown to include a set of legs 16 that support lifting column 12 in relation to the ground. Lifting column 12 is also shown to include a support fixture or carrier 18 to provide support of the vehicle in relation to lifting column 12.

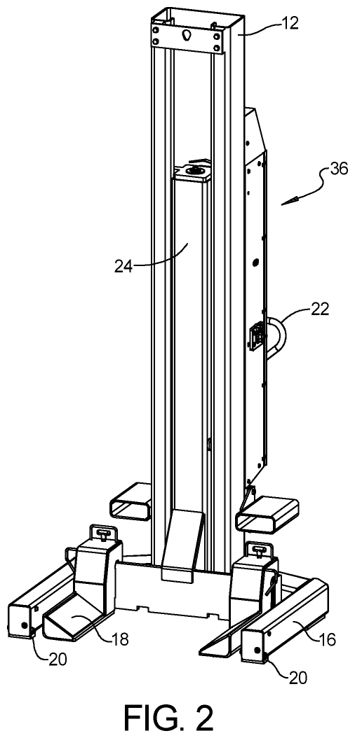

As further shown in FIG. 2, the columns 12 also have wheels 20 and handles 22, permitting the columns 12 to be moved along the ground. The columns 12 may thus be selectively positioned with relative ease, as may be desired to accommodate different vehicles having different wheel spacing or numbers of wheels (e.g., to move additional columns 12 into place or to move excess columns 12 away, etc.), to replace a first column 12 with a second column 12 for maintenance of the first column 12, etc.

As shown in FIG. 2, each column 12 further comprises a lift mechanism which is shown as a hydraulic system 24. The hydraulic system 24 is operable to move a carrier 18 vertically relative to the ground. The carrier 18 is configured to engage a component of the vehicle (e.g., the wheel, etc.), to thereby enable the columns 12 to raise and lower the vehicle relative to the ground. The configuration of the carrier 18 can vary to accommodate various vehicles as would be understood by one skilled in the art.

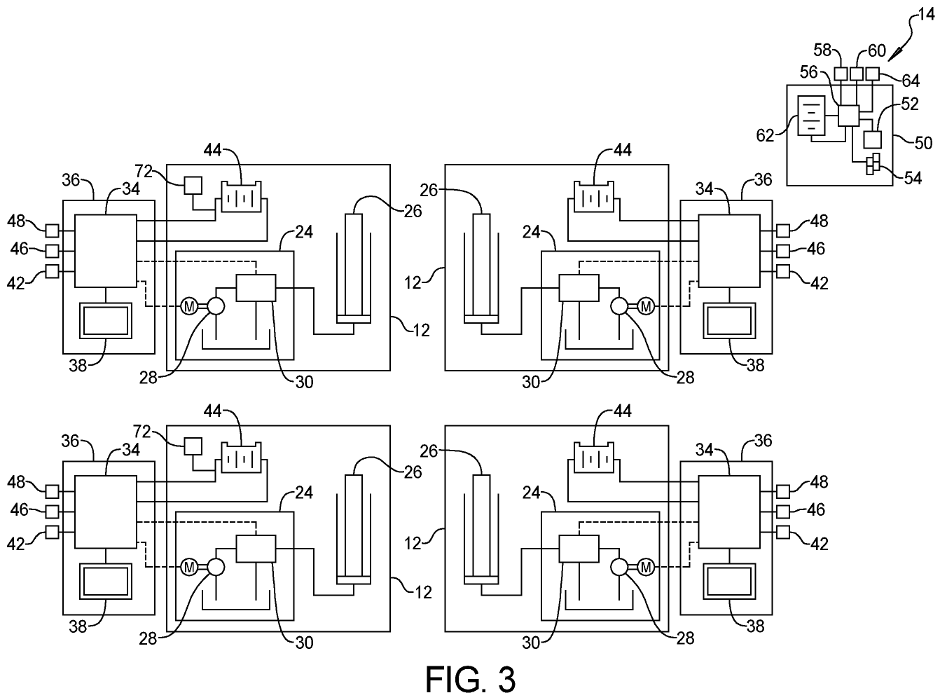

As shown in further detail in FIG. 3, in the exemplary embodiment, each hydraulic system 24 of the present example can include a hydraulic cylinder and piston 26, a pump 28, and a series of valves 30 controlling the flow of hydraulic fluid. In particular, the pump 28 and valves 30 are in fluid communication with hydraulic cylinder and piston 26, such that the pump 28 and the valves 30 communicate fluid to or from the cylinder and piston 26. The carrier 18 ascends and descends with the piston of hydraulic cylinder and piston 26, such that the pump 28 and the valves 30 may be controlled to control the vertical height at which carrier 18 is positioned.

A processor 34 is in electrical communication with the pump 28 and the valves 30 to control operation of the pump 28 and the valves 30. Of course, any other suitable structures, components, or techniques may be used for a hydraulic system 24. For instance, any suitable systems, features, mechanisms, or components may be used in addition to or in lieu of hydraulic system 24, including but not limited to a screw, belt, or gear mechanism, such as to raise or lower carrier 18.

Each lift column 12 further includes a control unit 36, which may be used to control the operation, monitoring, and/or programming of lift system 10. For instance, any one of the control units 36 may be used to define participation in ad hoc column control groups based on available columns 12; then control the columns 12 while in the ad hoc column control group. Control unit 36 can also have a display 38 that is configured to provide the operator with visual indication of which columns 12 have been assigned to the ad hoc column control group.

Display 38 may include a graphical representation of a vehicle and graphical representations of the available columns 12 positioned in relation to the graphical representation of the vehicle. Control unit 36 may illuminate the graphical representations of the available lift columns that have been selected for the ad hoc control group, providing the operator with immediate visual confirmation of which columns 12 have been selected and where those columns 12 are in relation to the vehicle. Control unit 36 includes a processor 34, which is operable to process and relay information/commands to/from other components of the control unit 36.

It should be understood that each control unit 36 may be in communication with a remote control unit 14. For instance, when an operator uses a control unit 36 to create an ad hoc column control group, the identity of the columns 12 in that control group may be transmitted to the remote control unit 14. In addition, a lift command entered through control unit 36 may be sent to the remote control unit 14, and remote control unit 14 may then relay the lift command to columns 12 that have been assigned to the ad hoc column control group. The remote control unit 36 may function as the system controller. In alternate embodiments, the system controller may be a separate unit in wireless communication with both the remote control unit 14 and the control unit 36, or the system controller may be one of the control units 36 on one of the columns 12 existing in the system.

A wireless transceiver 42 is also provided at each column 12 represented in FIG. 3, and is operable to wirelessly relay information and commands between a column 12 and the remote control unit 14 as will be described in greater detail below. The wireless transceiver 42 can be a radio frequency (RF) transceiver and/or may take other forms that will be apparent to those of ordinary skill in the art in view of the teachings herein.

As also shown in FIG. 3, each column (2) includes a respective battery 44. The batteries 44 are rechargeable and are operable to power all aspects of operation of their respective columns 12. In particular, each battery 44 is operable to power the pump 28, control unit 36, transceiver 42, and/or any other electrically powered component in each column 12.

At least one column 12 and more preferably all of the columns 12 further include an optical receiver 46. The optical receiver 46 can be an Infrared (IR) receiver or other form of optical receiver. The columns 12 can further or alternatively include an optical transmitter 48.

The remote control unit 14 can include a housing 50 having a display 52 and a series of input buttons 54. Input buttons may be designated for controlling lift motion or for navigating display menus on the remote control. Input buttons designated for controlling lift motion may only be enabled when the lift system is enabled for wireless remote lift operation. The remote control unit 14 can further include a processor 56 in communication with the display 52 and the series of input buttons 54 as well as a wireless transmitter/receiver 58 and an optical transmitter 60. The remote control unit 14 includes a battery 62. The battery 62 can be rechargeable and operable to power all aspects of operation of the remote control unit 14. In particular, the battery 62 is operable to power the display 52, the processor 56, the wireless transmitter/receiver 58 and the optical transmitter 60 and/or any other electrically powered component in the remote control unit 14. The remote control unit 14 can further or alternatively include an optical receiver 64.

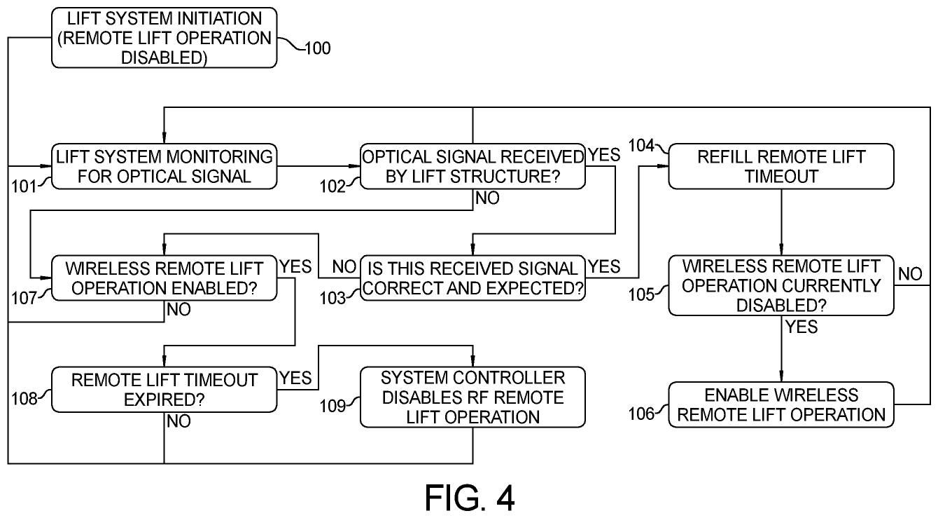

With reference to FIG. 4, a flow diagram of the control operation for restricting remote operation of the lift system 10 using an optical wireless communication system 46/60 to permit wireless control of the lift system according to the principles of the present disclosure will now be described. As shown at step 100 the lift system 10 is initiated with the remote lift operation being initially in a disabled state. At step 101, the lift system 10 is monitoring for an optical wireless control signal. At step 102, it is determined whether an optical wireless control signal is received by one of the optical receivers 46 of the mobile lift columns 12. If an optical wireless control signal from the optical transmitter 60 is received, the control advances to step 103 where it is determined whether the received optical signal is correct and expected. For example, the optical signal may be unique to the lift system based upon system identifier assigned to the ad-hoc group, in which case the control will expect the unique signal and verify that it is correctly received. The unique signal may also be expected based upon lift model numbers, wireless channel number, or other factors that would be known and expected by the control. If at step 103 it is determined that the received signal is correct and expected, the control advances to step 104 where the remote lift timeout is reset. Lift timeout could be reset to a fixed time, or a variable time. For instance, the lift timeout may be reset to a longer time when the lift is in an idle state, and reduced to a shorter time when the lift is in a motion state. After step 104, control advances to step 105 where it is determined whether wireless remote lift operation is currently disabled. If at step 105 it is determined that wireless remote lift operation is not disabled, then control returns to step 101. If at step 105 it is determined that wireless remote lift operation is disabled, control advances to step 106 where wireless remote lift operation is enabled. If at step 102, an optical signal is not received by an optical receiver 46 of a lift column 12, the control advances to step 107. Also, at step 103 if it is determined that the received signal is not correct and expected, control advances to step 107. At step 107, it is determined whether wireless remote lift operation is enabled. If at step 107 it is determined that wireless remote lift operation is not enabled, control returns to step 101. If at step 107 it is determined that wireless remote lift operation is enabled, control advances to step 108 where it is determined whether remote lift timeout has expired. If at step 108 it is determined that remote lift timeout has not expired, control returns to step 101. If at step 108 it is determined that remote lift timeout has expired, control continues to step 109 where the system controller disables the wireless remote lift operation and control returns to step 101. The control operation of FIG. 4 insures that remote lift operation by the wireless signals is prevented unless an optical signal from optical transmitter 60 is received.

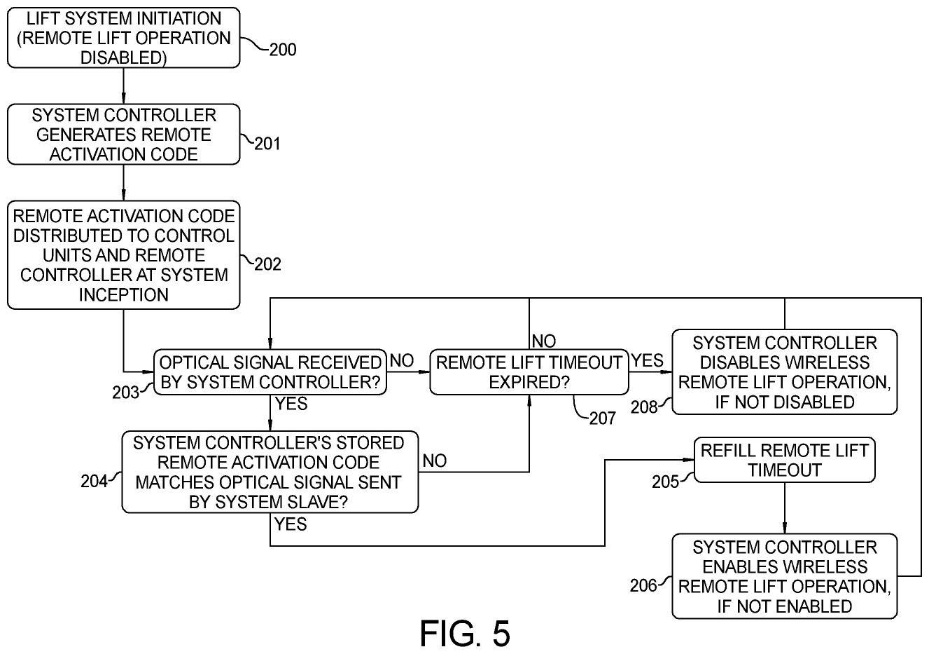

With reference to FIG. 5, an alternative flow diagram of the control operation for restricting remote operation of the lift system 10 using an optical wireless communication system 46/60 to permit wireless control of the lift system according to the principles of the present disclosure will now be described. As shown at step 200 the lift system 10 is initiated with the remote lift operation being initially in a disabled state. At step 201, the system controller generates a remote activation code. For example, the random activation code could be based upon a unique wireless radio address, random numbers generated at the formation of the ad-hoc group, or other factors determined by the system controller. Control then advances to step 202 where the remote activation code is distributed to the processors of the system slave columns 12 at system inception. At step 203, it is determined whether an optical wireless signal is received by the system controller. If an optical wireless control signal is received at step 203, the control advances to step 204 where it is determined whether the system controller's stored remote activation code matches the optical signal sent by the system slave columns 12. If at step 204 it is determined that the system controller's stored remote activation code matches the optical signal sent by the system slave, then control advances to step 205. At step 205, the remote lift timeout is refilled. Lift timeout could be reset to a fixed time, or a variable time. For instance, the lift timeout may be reset to a longer time when the lift is in an idle state, and reduced to a shorter time when the lift is in a motion state. The control then advances to step 206 where the system controller enables wireless remote lift operation if it is not enabled and control returns to step 203. If at step 203 it is determined that an optical wireless signal is not received by the system controller, the control advances to step 207. In addition, if at step 204 it is determined that the system controller's stored remote activation code does not match the optical signal sent by the system slave, then control advances to step 207. At step 207, it is determined whether the remote lift timeout has expired. If it is determined that the remote lift timeout has expired, then control advances to step 208 where the system controller disables the wireless remote lift operation if it is not disabled. Control then returns to step 203. If at step 207 it is determined that the remote lift timeout has not expired, control advances to step 203.

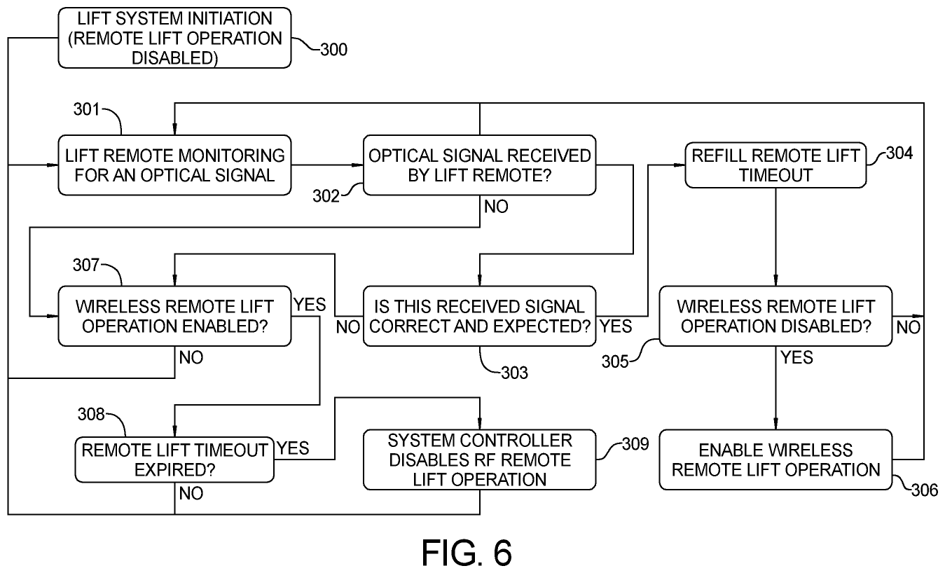

With reference to FIG. 6, a flow diagram of the control operation for restricting remote operation of the lift system 10 using an alternative optical wireless communication system including the optical wireless transmitter 48 on at least one of the remote lift columns 12 and the optical wireless receiver 64 on the remote control unit 14 to permit wireless control of the lift system according to the principles of the present disclosure will now be described. As shown at step 300 the lift system 10 is initiated when the remote lift operation is initially in a disabled state. At step 301, the lift remote 14 is monitoring for an optical wireless control signal. At step 302, it is determined whether an optical wireless control signal is received by the optical receiver 64 of the remote control unit 14. If the optical wireless control signal is received, the control advances to step 303 where it is determined whether the received optical signal is correct and expected. For example, the optical signal may be unique to the lift system based upon system identifier assigned to the ad-hoc group, in which case the control will expect the unique signal and verify that it is correctly received. The unique signal may also be expected based upon lift model numbers, wireless channels, or other factors that would be known and expected by the control. If at step 303 it is determined that the received signal is correct and expected, the control advances to step 304 where the remote lift timeout is reset. Lift timeout could be reset to a fixed time, or a variable time. For instance, the lift timeout may be reset to a longer time when the lift is in an idle state, and reduced to a shorter time when the lift is in a motion state. After step 304, control advances to step 305 where it is determined whether wireless remote lift operation is currently disabled. If at step 305 it is determined that wireless remote lift operation is not disabled, then control returns to step 301. If at step 305 it is determined that wireless remote lift operation is disabled, control advances to step 306 where wireless remote lift operation is enabled. If at step 302, an optical signal is not received by the optical receiver 64 of the remote control unit, the control advances to step 307. Also, at step 303 if it is determined that the received signal is not correct and expected, control advances to step 307. At step 307, it is determined whether wireless remote lift operation is enabled. If at step 307 it is determined that wireless remote lift operation is not enabled, control returns to step 301. If at step 307 it is determined that wireless remote lift operation is enabled, control advances to step 308 where it is determined whether remote lift timeout has expired. If at step 308 it is determined that remote lift timeout has not expired, control returns to step 301. If at step 308 it is determined that remote lift timeout has expired, control continues to step 309 where the system controller disables the wireless remote lift operation and control returns to step 301. The control operation of FIG. 6 insures that remote lift operation by the wireless signals is prevented unless an optical signal sent by an optical transmitter 48 of one of the mobile lift columns 12 is received by the remote control unit 14.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle lift system, comprising:
a plurality of mobile lift columns each including a wireless communication system for sending and receiving wireless signals, at least one of the mobile lift columns including an optical receiver;
a remote control unit having a wireless communication system capable of transmitting wireless control signals and the remote control unit having an optical transmitter; and
a control unit associated with the plurality of lift columns for controlling operation of the plurality of lift columns, said control unit receiving control signals from the wireless communication system and the optical receiver and enabling operation of the mobile lift columns when both an optical signal transmitted by the remote control unit is received by the optical receiver and a wireless control signal transmitted by a system controller is received by the wireless communication system.

2. The vehicle lift system according to claim 1, wherein the wireless signals include RF signals.

3. The vehicle lift system according to claim 1, wherein the optical transmitter transmits IR signals.

4. The vehicle lift system according to claim 1, wherein the control unit enables remote lift operation by the wireless signals if an optical signal is received by the optical receiver and disables remote lift operation by the wireless signals if an optical signal is not received.

5. A vehicle lift system, comprising:
a plurality of mobile lift columns each including a wireless communication system for sending and receiving wireless signals, at least one of the mobile lift columns including an optical transmitter;
a remote control unit having a wireless communication system capable of transmitting wireless control signals and the remote control unit having an optical receiver; and
a control unit associated with the remote control unit for controlling operation of the plurality of lift columns, said control unit receiving control signals from the wireless communication system and the optical receiver and enabling operation of the mobile lift columns when both an optical signal from at least one of the mobile lift columns is received by the optical receiver of the remote control unit and a wireless control signal transmitted by a system controller is received by the wireless communication system.

6. The vehicle lift system according to claim 5, wherein the wireless signals include RF signals.

7. The vehicle lift system according to claim 5, wherein the optical transmitter transmits IR signals.

8. The vehicle lift system according to claim 5, wherein the control unit enables remote lift operation by the wireless signals if an optical signal is received by the optical receiver and disables remote lift operation by the wireless signals if an optical signal is not received.
